(19) United States
(12) Patent Application Publication
(10) Pub. No.: US 2024/0402648 A1
(43) Pub. Date: Dec. 5, 2024

(54) AN IN SITU HOLOGRAPHIC IMAGING SYSTEM FOR MARINE STUDIES

(71) Applicant: FLORIDA ATLANTIC UNVERSITY BOARD OF TRUSTEES, Boca Raton, FL (US)

(72) Inventors: Aditya R. NAYAK, North Fort Pierce, FL (US); Malcolm MCFARLAND, North Fort Pierce, FL (US); James SULLIVAN, North Fort Pierce, FL (US); Fraser DALGLEISH, North Fort Pierce, FL (US)

(21) Appl. No.: 18/698,066

(22) PCT Filed: Oct. 6, 2022
(86) PCT No.: PCT/US22/45872

§ 371 Date: Apr. 3, 2024

Related U.S. Application Data
(60) Provisional application No. 63/288,895, filed on Dec. 13, 2021.

(51) Int. Cl. G03H 1/04; G03H 1/00

(52) U.S. Cl. CPC G03H 1/0443; G03H 1/0005; G03H 2001/0447; G03H 2210/63

(57) ABSTRACT

The invention improves holographic imaging systems by being modular with deployment in a lens-less configuration or with a microscope objective, leading to a resolution range of 5.5 and to 0.5 μm/pixel, respectively, and resulting in a resolvable particle size range of several microns to a few cm between two setups. The invention includes variable sampling length between two windows (e.g., a sampling volume of 71.4 mL per hologram at 12 cm). Holograms are recorded with a 4920×3280 pixels digital camera. i.e., 15.3 MB per image, at a maximum rate of 3.2 Hz, such that free stream water sampling a 14 L/minute occurs. This is orders of magnitude higher than sampling of other imaging systems while including larger/variable sample volume, inclusion of copper shutters to prevent biofouling during long-term deployments, including deployment in different operation modes. No single previous system achieves all these things at the same time.

### CROSS-REFERENCE TO RELATED APPLICATIONS

This PCT application claims the benefit under 35 U.S.C. § 119 (e) of Application Ser. No. 63/288,895 filed on Dec. 13, 2021 entitled AN IN SITU HOLOGRAPHIC IMAGING SYSTEM FOR MARINE STUDIES and whose entire disclosure is incorporated by reference herein.

### STATEMENT REGARDING FEDERALLY SPONSORED RESEARCH OR DEVELOPMENT

This invention was made with government support under grant number 1634053 awarded by the National Science Foundation. The government has certain rights in the invention.

### BACKGROUND OF THE INVENTION

The present invention is related generally to imaging systems and, more particularly, to a submersible in-line holographic imaging system developed for in situ aquatic studies.

An in-line hologram is an image of the diffraction pattern resulting from the interference between light scattered by particles and the undisturbed part of a coherent beam. Digital reconstruction of the hologram reproduces in-focus images of all particles in the original 3-D sample volume. All in-focus particles within the reconstructed 3-D volume can be compressed into a 2-D composite image for analysis.

Moreover, digital holography has increasingly been embraced by the oceanographic community over the past few years as a valuable tool, due to its ability to facilitate characterization of 3-D spatial distributions of particles at high resolution. Several commercial and custom-built instruments have been used previously to characterize particle/phytoplankton community composition, harmful algal blooms, thin layers, bubbles, marine snow and oil spills in situ in diverse marine environments. See FIGS. 1A-1C pertaining to a sample in situ hologram and different reconstructed planes showing in-focus particles (diatom chains) at a particular depth. FIGS. 2A-2C depict another sample in-focus image and plots of phytoplankton thin layers in Eastsound, Washington, showing all particles recorded from holograms taken during a slow vertical profile through the water column. FIG. 3A-3F depict sample raw holograms and related plots of particle distributions, including those of harmful algal bloom causing species, at three different locations in western Lake Erie. FIG. 3B shows a bump in the particle size distribution (PSD) spectrum which corresponds to size of Microcystis colonies that have shown enhanced vertical migration (Moore et al. 2017). Moreover, the depth distribution of Microcystis and Planktothrix communities varied, with the Microcystis populations consistently nearer to the surface relative to Planktothrix, when either both are present together or separately (Moore et al., 2019). Furthermore, FIG. 4 depicts a thin cilliate layer in the Delaware shelf obtained by a holographic system for examining biophysical coupling in the shelf. The hologram of FIG. 4 and its related studies allowed for the study of the evolution of this layer and predator (e.g., copepod) interactions with it over time. Reference character 4A shows enhanced concentration of ciliates within the thin layer while reference character 4B identifies a copepod, potentially feeding on the ciliates.

Several off-the-shelf commercial in situ holographic imaging systems are currently available to researchers (e.g., 4Deep's holographic microscope, Sequoia Scientific's LISST-HOLO). While these instruments represent significant advances, there are certain limitations associated with the ability to image undisturbed particle fields (due to small sample volumes) and limited particle size range.

Thus, there remains a need for an underwater imaging system that can image undisturbed particle fields over a wide particle size range. The present invention solves this problem.

All references cited herein are incorporated herein by reference in their entireties.

### BRIEF SUMMARY OF THE INVENTION

A submersible holographic imaging system is disclosed. The system comprises: a camera portion and a laser portion oriented parallel to each other on a base plate and separated from each other by a distance (e.g., 1-20 cm) which can be adjusted, wherein the camera portion has an imaging window that is located across from and aligned with a laser illumination window in the laser portion; the camera portion can operate lens-less or with microscope objectives; a storage unit coupled to the camera portion for saving image data therein; and a power supply for powering the camera portion, the laser portion and the storage unit.

A method for implementing a submersible holographic imaging system is disclosed. The method comprises: configuring a camera portion and a laser portion to be oriented parallel to each other on a base plate and separated from each other by a distance which can be adjusted and wherein the camera portion comprises an imaging window that is located across from and aligned with a laser illumination window in the laser portion; configuring the camera portion to operate lens-less or with microscope objectives; providing an onboard storage unit for saving image data therein and coupling the storage unit to the camera portion; and coupling an onboard power supply to the camera portion, the laser portion and the storage unit.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A depicts a sample in situ hologram and different reconstructed planes showing in-focus particles (diatom chains) at a particular depth;

FIG. 1B is an enlarged portion of FIG. 1A having a particle in focus at y=0.1 mm from the focal plane;

FIG. 1C is another enlarged portion of FIG. 1A having a particle in focus at y=18.7 mm from the focal plane;

FIG. 2A depicts a phytoplankton thin layer in a fjord at Eastsound, Washington where a holographic system was deployed by Nayak, et al. in 2018, showing a high concentration of Ditylum sp. chains present within the thin layer; this sample in-focus image shows all particles recorded in a single hologram;

FIG. 2B is a plot of the vertical profile of the Ditylum sp. concentration in FIG. 2A;

FIG. 2C is a particle size distribution of the Ditylum sp. of FIG. 2A;

FIG. 3A is a first sample raw hologram in Detroit River waters showing them dominated by small inorganic particles and flagellates;

FIG. 3B is a second raw hologram in Maumee Bay waters showing them dominated by globular Microcystis colonies;

FIG. 3C is a third raw hologram in Central Basin waters showing them dominated by hair-like Planktothrix cells;

FIG. 3D is a particle size distribution plot of the Detroit River waters corresponding to FIG. 3A;

FIG. 3E is a particle size distribution plot of the Maumee Bay waters corresponding to FIG. 3B;

FIG. 3F is a particle size distribution plot of the Central Basin waters corresponding to FIG. 3C;

FIG. 4 depicts an image of zooplankton distributions off the Delaware Shelf using another holographic system and showing enhanced concentration of ciliates within a thin layer, as well as copepod, potentially feeding on the ciliates;

FIG. 5 depicts a first embodiment (also referred to as “Unit 1”) of the present invention and depth-rated to 800 meters;

FIG. 6 depicts a second embodiment (also referred to as “Unit 2”) of the present invention and depth-rated to 200 meters, with CSH referring to copper shutters;

FIG. 6A is another top view of the second embodiment of FIG. 6 identifying key components of the present invention;

FIG. 7 depicts the first embodiment of the present invention being deployed for use at the Indian River Lagoon in Florida;

FIGS. 8A-8B depict holographic images obtained with the present invention and numerically reconstructed using a depth plane at 11.7 cm distance and wherein the images were obtained from a natural sea water sample in the lab (5.5 μm per pixel) and wherein linear particles are diatom chains, most likely Skeletonema sp.;

FIG. 8C-8D depict sample raw holograms obtained from a field deployment in the St. Lucie Estuary region of the Indian River Lagoon, Florida (5.5 μm per pixel), showing assorted plankton and detrital material;

FIGS. 9A-9D comprise sample processed holograms recorded in situ, showing variations at stations based on Karenia brevis concentrations;

FIG. 10 is a prior art diagram identifying features of a Karenia brevis cell; and

FIGS. 11A-11D are reconstructed AUTOHOLO images of white sturgeon larvae with zoomed in key characteristics at various flow rates of (11A) 0.686 m/s; (11B) 1.37 m/s; (11C) 2.74 m/s; and (11D) 4.80 m/s, respectively.

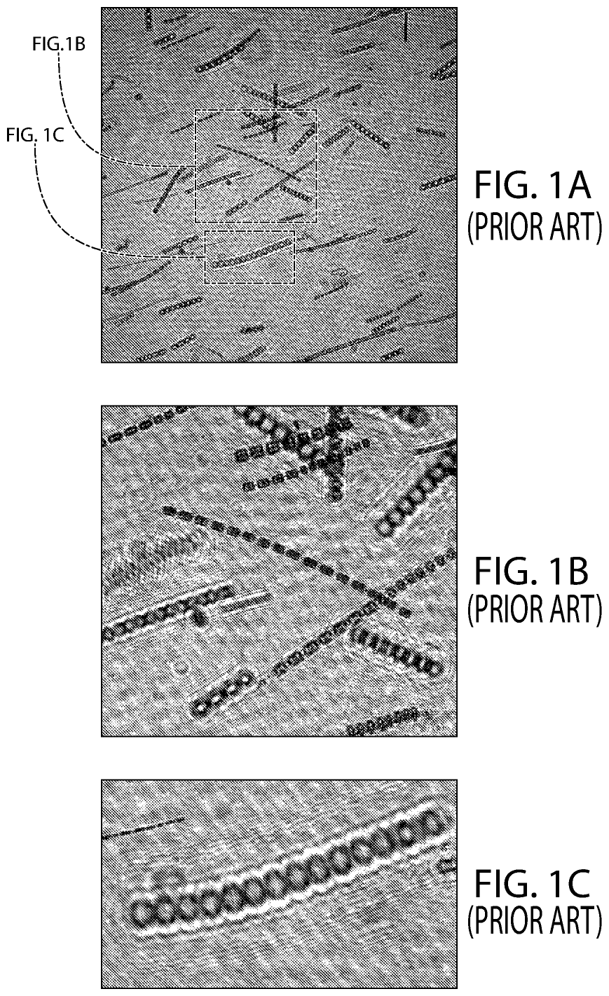

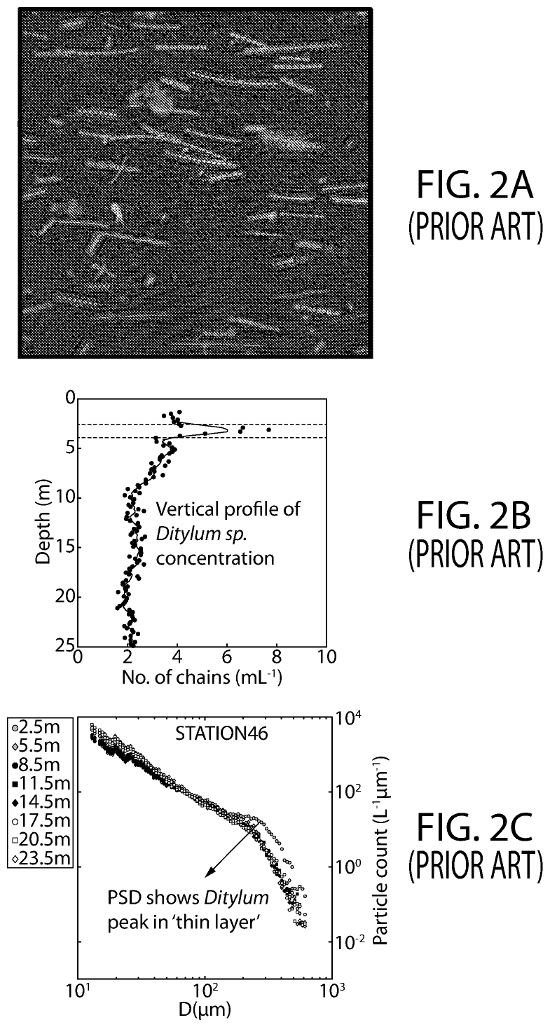

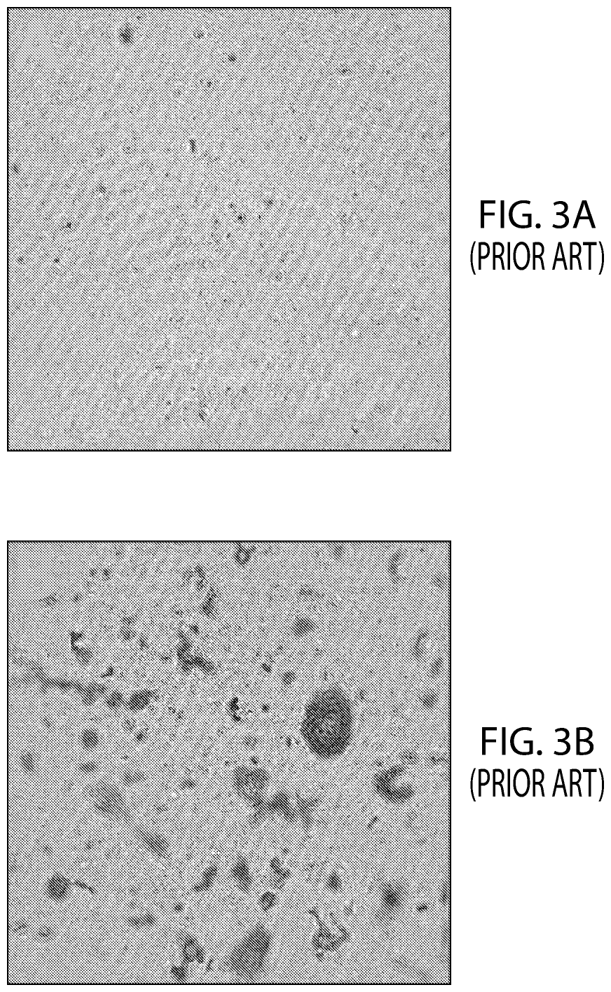

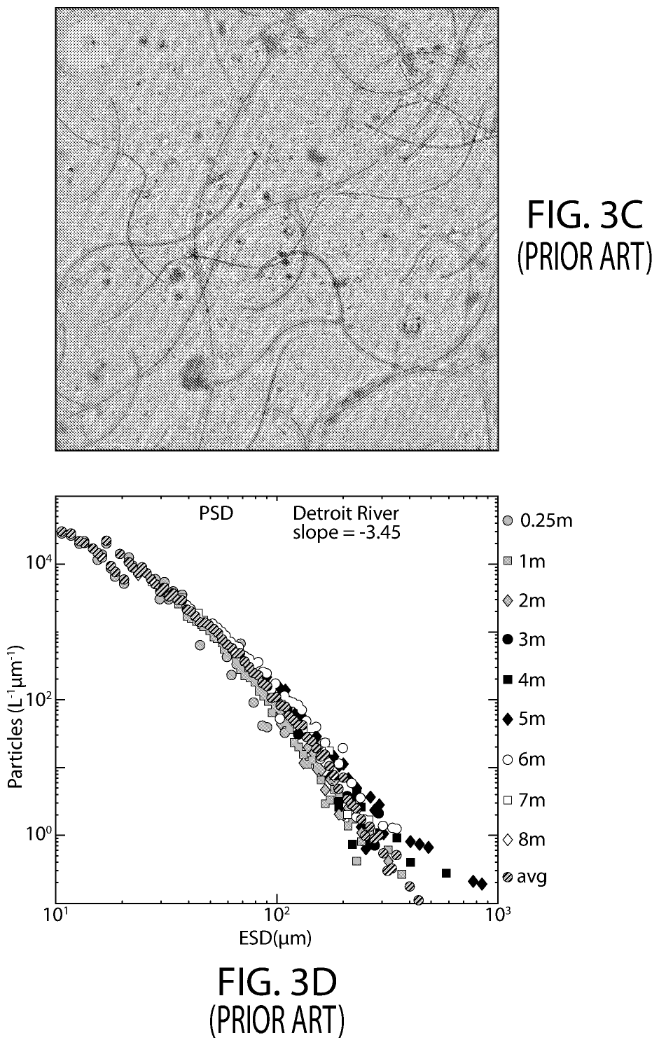

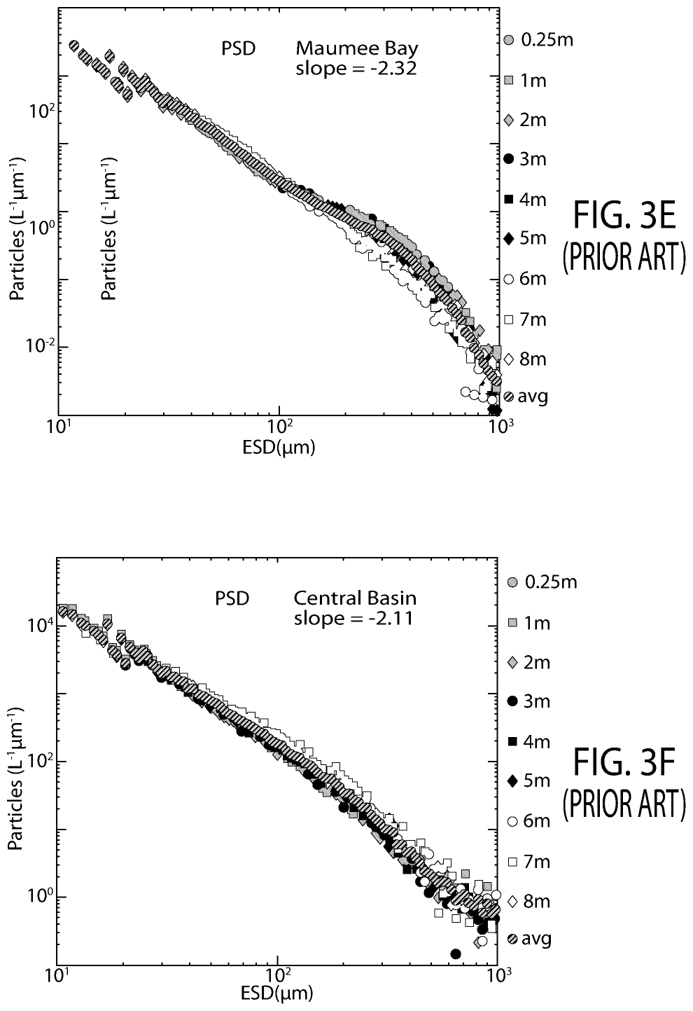

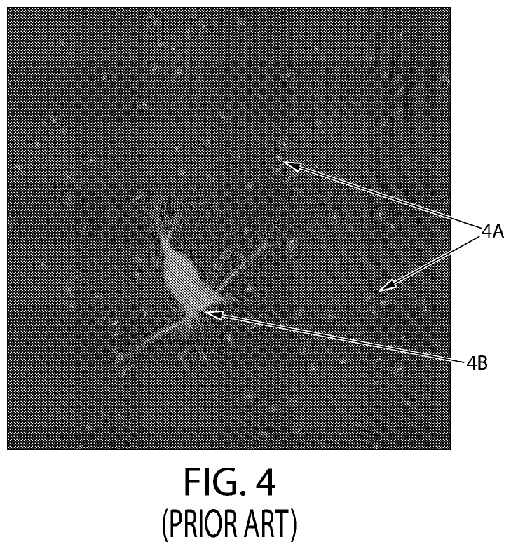

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

The apparatus and method of the present invention, which also goes by the name, AUTOHOLO, is a prototype submersible holographic imaging system developed for in situ aquatic studies at Florida Atlantic University's Harbor Branch Oceanographic Institute (FAU-HBOI), as part of an NSF funded project (Award #1634053). Briefly, digital holography involves illuminating the sampling volume of interest with a coherent beam of light and recording the diffraction patterns resulting from interference between light scattered by particles in the volume and the undisturbed light beam. Reconstruction of the hologram in different sections within the sampling volume, provides 3-D information on the characteristics and spatial distributions of particles/organisms. This ability of holography that combines high resolution and the capability to image a large sampling volume in situ is not currently achievable by any other instrument/technique.

The AUTOHOLO has been designed to be modular with deployment possible in a lens-less configuration as well as with different microscope objectives, leading to a resolution of 0.5-5.5 μm/pixel. Resolutions of 2.3 μm/pixel and 5.5 μm/pixel, for example, correspond to resolved particle size ranges from ˜ 9.2 μm-1.45 cm and ˜22 μm-3.5 cm, respectively. Either configuration can be used based on the size range of interest to a particular study. In the lens-less configuration (5.5 μm/pixel resolution), at a representative 12 cm sampling length between the two windows, a sample volume of 71.4 mL per hologram is recorded. Holograms are recorded with a 4920×3280 pixels digital camera, corresponding to 15.3 MB per image, at a maximum rate of 3.2 Hz; at this sampling rate, 14 L of water can be sampled free stream every minute in the above configuration. This is orders of magnitude higher than what other standard in situ imaging systems can sample (e.g., Imaging Flow CytoBot). The unit is equipped with a 330 Wh battery pack; the system consumption is around 20 W, thus enabling data to be continuously recorded for ˜ 16.5 hours; the system can record data in continuous or “burst” mode. In “burst” mode, data is recorded for a certain duration of time before the instrument goes in standby mode and this is repeated periodically. This enables battery saving and facilitates longer deployments up to several weeks.

The variable 1-20 cm spacing between the windows (sample volume length) allow for studying particle fields in their natural environment, minimizing particle fragmentation. The AUTOHOLO has a 4 TB solid state drive storage capacity to record the data and can also be pre-programmed prior to deployments to acquire data continuously or in ‘burst’ mode, where data is acquired periodically at fixed intervals.

### Salient Features:

(1) Adjustable gap between the windows, variable from 1-20 cm. This leads to optimization of the instrument for a wide variety of applications in diverse environments. For example, in highly turbid environments, the gap could be lowered to shorter lengths to ensure good quality holograms are recorded. With a fixed gap (as with existing commercial systems), tunability to local conditions is not possible. At the opposite end, in clear water, we can go to 20 cm, thus sampling much larger sampling volumes than with other techniques or even other commercially available holographic imaging systems.
(2) Modular optical configuration (lensless/microscope objectives) allows for deployment in versatile applications. For example, smaller organisms such as Karenia brevis (20-50 micron sized dinoflagellate causing red tide blooms), can be successfully imaged by introducing a high resolution microscope objective. For larger phytoplankton, fish larvae, or colonial cyanobacteria like Microcystis, the lensless configuration is preferable.
(3) Anti-biofouling copper shutters which can prevent algal growth on windows during long-term deployments. Other commercially available holographic imaging systems do not have this to the best of our knowledge (although there may be other oceanographic instruments with these shutters).
(4) Applications tested successfully so far: phytoplankton and zooplankton distributions, characterizing harmful algal blooms, and studying fish larvae. Future applications could include microplastics and marine snow research.

As can be seen most clearly in FIG. 6A, and as discussed above, the AUTOHOLO includes:
The recording medium is a 4920×3280 (16 MP) high resolution camera (3.2 Hz maximum);
Modular system with a lens-less configuration or a microscope objective, leading to a resolution of 5.5 μm/pixel (lens-less, higher resolution with microscope objective);
Sample resolvable particle size range of 22 μm-3.5 cm for the lens-less configuration, or 11 μm-1.75 cm with a 2× objective lens;
Variable distance between windows allows for sample volumes of up to 71.4 mL per hologram, i.e., ˜ 14 L of water sampled per minute;
Deployable in profiling or towed mode, a surface buoy, or on a benthic platform;
Continuous or “burst” mode recording allows for flexibility in length of deployment durations;
Unit 2 includes anti-biofouling copper shutters for long-term deployments.

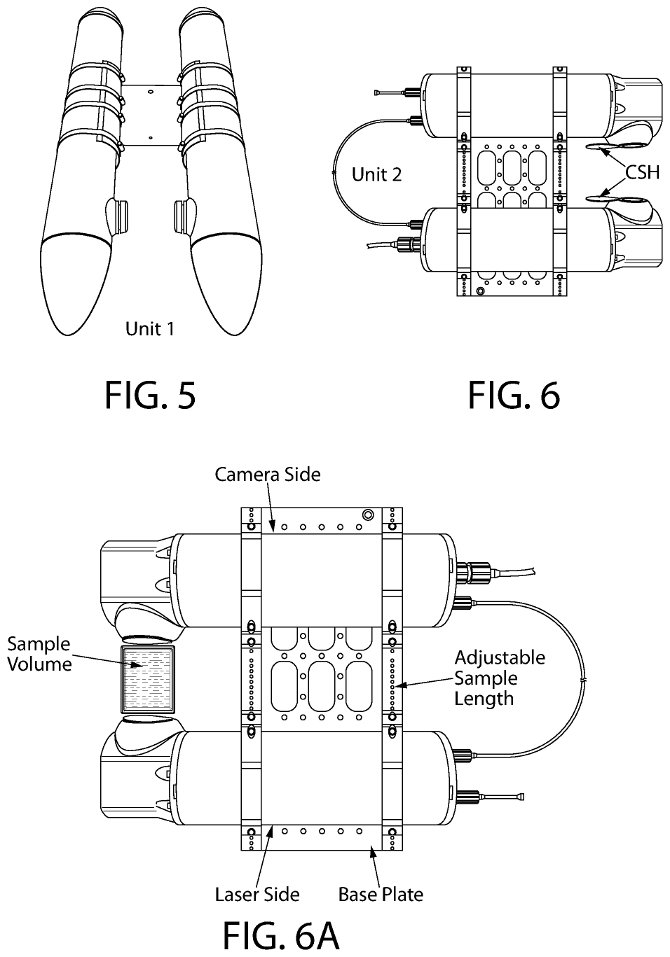

Laboratory and field trials have been completed successfully. Two units, targeted towards deep (˜ 800 m, see FIGS. 5 and 7) and shallow water (˜ 200 m, see FIGS. 6-6A) applications have been developed. Ongoing research includes working with collaborators to develop machine learning algorithms for automated classification to enable efficient post-processing of data.

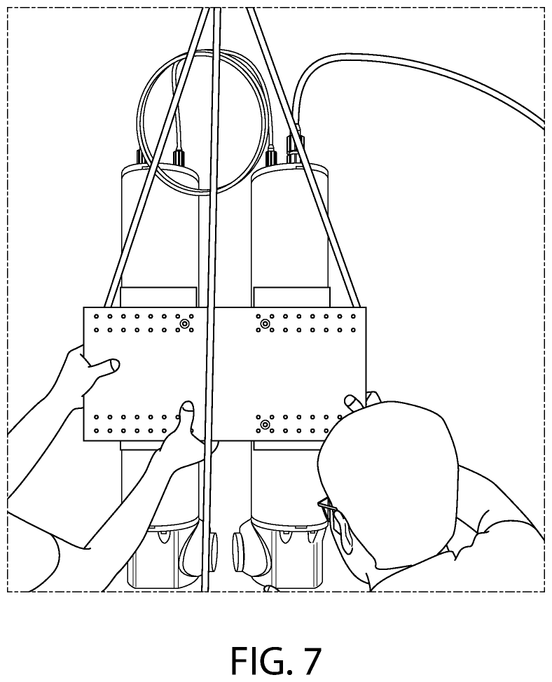

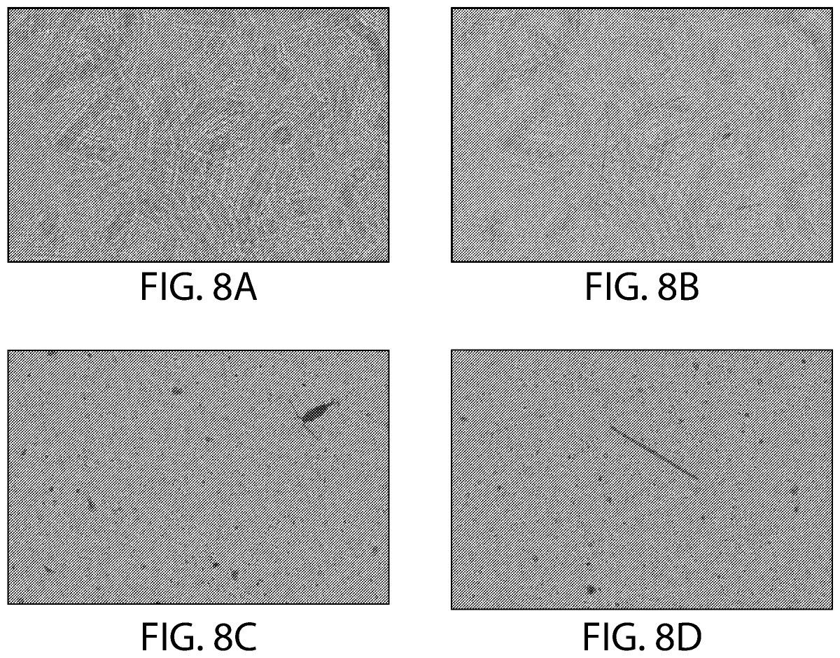

FIGS. 8A-8D depict AUTOHOLO field and laboratory test images.

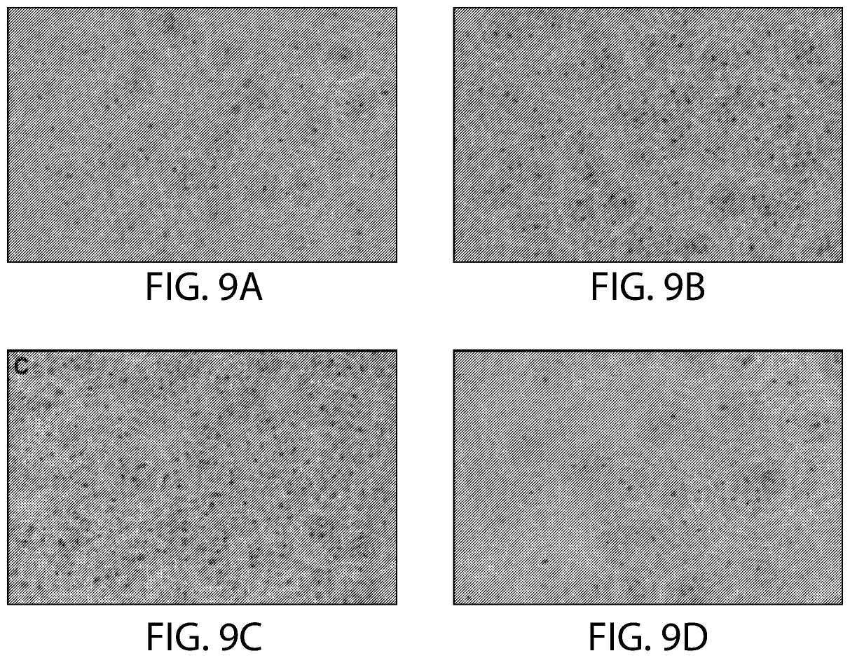

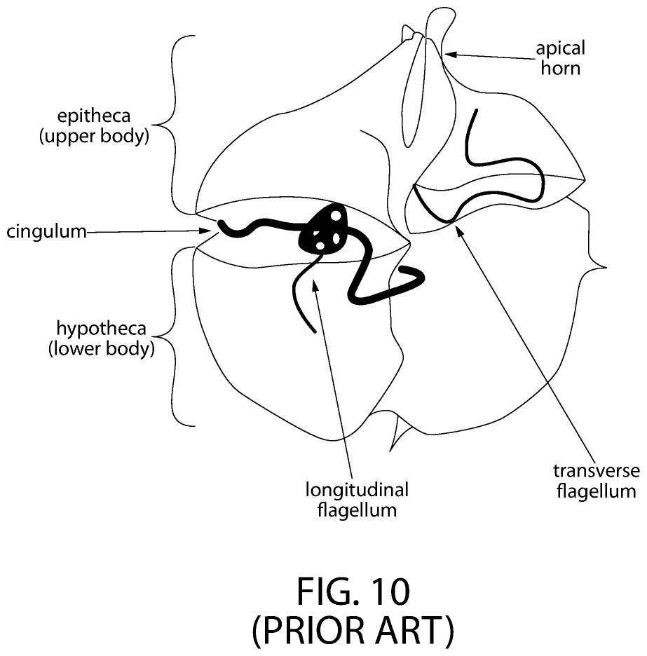

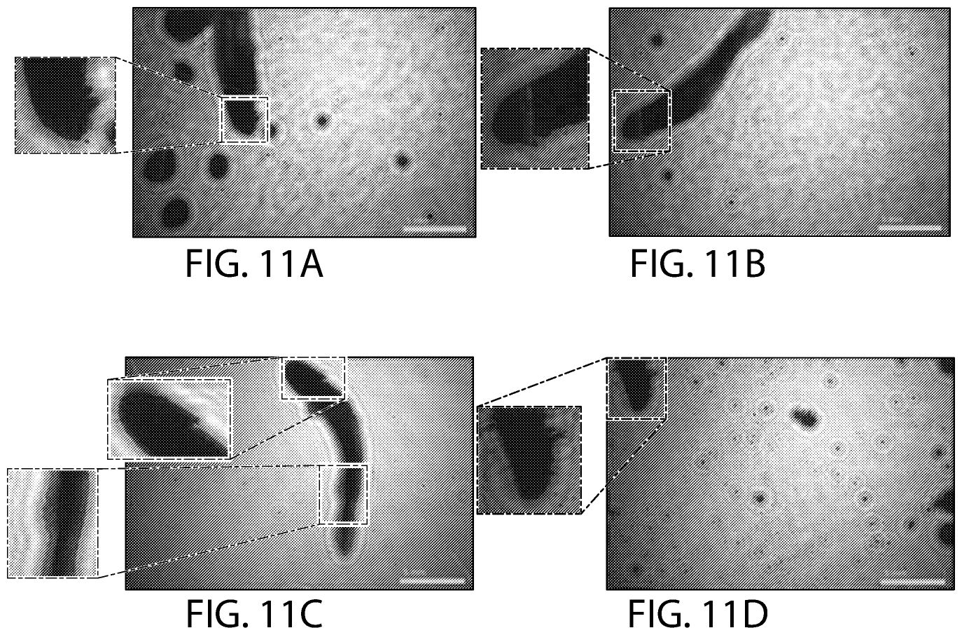

Applicant has also deployed the present invention towards red tide (Karenia brevis) research (FIGS. 9A-9D and FIGS. 10A-10B) and to fish larvae studies (FIGS. 11A-11D), demonstrating the diverse research applications of the present invention.

In particular, a persistent Karenia brevis bloom was observed in mid-December 2020 along the southwest Florida coastline. A combination of lab-based and in situ methods were used to record and process holograms over the course of the bloom. A field deployment of the AUTOHOLO system was conducted off Fort Myers, Florida. In situ holographic images were recorded at a frame rate of 2 Hz from four different stations (Stations 1-4) at different geographic locations. The images recorded had a resolution of 0.423 μm/pixel resulting in a field of view (FOV) of 1.39×2.08 mm. Between 200-300 images were recorded in all but two datasets with a sample length of 4 cm, corresponding to a sample volume of 0.12 mL per image. At Station 1, images were also recorded with a sample length of 6 cm, corresponding to a 0.06 mL sample volume. Surface and sub-surface water samples were collected at each of these four stations for further lab analysis using benchtop holographic imaging and flow cytometry.

FIGS. 9A-9D comprise sample processed holograms recorded in situ, showing variations at stations based on K. brevis concentrations. FIG. 9A depicts Station 1.4 cm sample length. FIG. 9B depicts Station 2, 4 cm sample length. FIG. 9C depicts Station 3, 2 cm sample length and FIG. 9D depicts Station 4, 4 cm sample length.

Karenia brevis cells are 18 to 45 μm wide and 10 to 15 μm thick, with their width being slightly greater than their length (Steidinger et al., 1978, Faust and Gulledge, 2022, Steidinger, 2009). The epitheca has an apical groove at the top, while the hypotheca, larger in size than the epitheca, has a notch at the bottom. The cingulum, which encompasses the cells in the middle, has a transverse flagellum (Steidinger et al., 1978, Faust and Gulledge, 2002, Haywood et al., 2004). See FIG. 10. The standard AUTOHOLO camera resolution (5.5 μm/pixel) is incapable of recognizing these distinctive features of K. brevis that differentiate it from other species. Thus, the optical setup was modified by incorporating a 10× objective along with other minor optical path adjustments, resulting in a higher resolution of 0.423 μm/pixel.

With regard to the fish larvae studies, a collage of sample in-focus images of white sturgeon larvae was obtained at four different flow velocities (0.686 m/s; 1.37 m/s; 2.74 m/s and 4.80 m/s) as shown in FIGS. 11A-11D which are reconstructed AUTOHOLO images of white sturgeon larvae with zoomed-in key characteristics at the various flow rates. In all cases, including at the peak flow velocities (4.8 m/s), the larvae were shown to be sufficiently well capture in the images. In focus holograms also captured the unique characteristics of sturgeon larvae-specifically their dorsal fins and barbells-which can be used to distinguish and separate sturgeon larvae from other larval fish species.

### REFERENCES

S. Talapatra, J. Hong, M. McFarland, A. R. Nayak, C. Zhang, J. Katz, J. Sullivan, M. Twardowski, J. Rines, and P. Donaghay, “Characterization of biophysical interactions in the water column using in situ digital holography,” Mar. Ecol. Prog. Ser., 473, 29-51 (2013).
S. Talapatra, J. Sullivan, J. Katz, M. Twardowski, H. Czerski, P. Donaghay, J. Hong, J. Rines, M. McFarland, A. R. Nayak and C. Zhang, “Applications of in situ digital holography in the study of particles, organisms and bubbles,” in Proc. SPIE, Ocean Sensing and Monitoring IV, 8372, 837205 (2012).
A. R. Nayak, M. McFarland, J. Sullivan and M. Twardowski, “On plankton distributions and biophysical interactions in diverse coastal and limnological environments,” in Proc. SPIE, Ocean Sensing and Monitoring X, 10631, 106310P (2018). T. Moore, C. Mouw, J. Sullivan, M. Twardowski, A. Burtner, A. Ciochetto, M. McFarland, A. R. Nayak, D. Paladino N. Stockley, T. Johengen, A. Yu, S. Ruberg, and
A. Weidemann, “Bio-optical properties of cyanobacterial blooms in western Lake Erie,” Front. Mar. Sci., 4, 300 (2017).
A. R. Nayak, M. McFarland, J. Sullivan and M. Twardowski, “Evidence for ubiquitous preferential particle orientation in representative oceanic shear flows,” Limnol. Oceanogr. 63 (1), 122-143 (2018).
T. S. Moore, J. Churnside, J. Sullivan, M. Twardowski, A. R. Nayak, M. McFarland, N. Stockley, R. Gould, T. Johengen and S. Ruberg,”. Remote Sensing of Environment, 225, 347-367. (2019).
Steidinger, K. A., Truby, E. W., Dawes, C. J., 1978. “Ultrastructure Of The Red Tide Dinoflagellate Gymnodinium Breve”. I. General Description 1, 2, 3. Journal of Phycology 14, 72-79.
Faust, M. A., Gulledge, R. A., 2002. “Identifying harmful marine dinoflagellates”. Steidinger, K. A., 2009. “Historical Perspective on Karenia brevis red tide research in the Gulf of Mexico”. Harmful Algae 8, 549-561.
Haywood, A. J., Steidinger, K. A., Truby, E. W., Bergquist, P. R., Bergquist, P. L., Adamson, J., Mackenzie, L., 2004. “Comparative Morphology And Molecular Phylogenetic Analysis Of Three New Species Of The Genus Karenia (Dinophyceae) From New Zealand1: Three New Species of Karenia”. Journal of Phycology 40, 165-179.

While the invention has been described in detail and with reference to specific examples thereof, it will be apparent to one skilled in the art that various changes and modifications can be made therein without departing from the spirit and scope thereof.

What is claimed is:

1. A submersible holographic imaging system, said system comprising:
a camera portion and a laser portion oriented parallel to each other on a base plate and separated from each other by a distance which can be adjusted, said camera portion having an imaging window that is located across from and aligned with a laser illumination window in said laser portion;
said camera portion that can operate lens-less or with microscope objectives;
a storage unit coupled to said camera portion for saving image data therein; and
a power supply for powering said camera portion, said laser portion and said storage unit.

2. The submersible holographic imaging system of claim 1 wherein said camera portion comprises a camera of 4920×3280 pixels for acquiring image data at up to 3.2 Hz.

3. The submersible holographic imaging system of claim 1 wherein said adjustable distance is 1-20 cm.

4. The submersible holographic imaging system of claim 2 wherein said camera can achieve a 5.5 μm/pixel resolution.

5. The submersible holographic imaging system of claim 1 wherein said system can be configured to acquire image data continuously or in a burst mode.

6. The submersible holographic imaging system of claim 1 comprising respective shutters for each of said windows.

7. A method for implementing a submersible holographic imaging system, said method comprising:
configuring a camera portion and a laser portion to be oriented parallel to each other on a base plate and separated from each other by a distance which can be adjusted and wherein said camera portion comprises an imaging window that is located across from and aligned with a laser illumination window in said laser portion;
configuring said camera portion to operate lens-less or with microscope objectives;
providing an onboard storage unit for saving image data therein and coupling said storage unit to said camera portion; and
coupling an onboard power supply to said camera portion, said laser portion and said storage unit.

8. The method of claim 7 wherein said camera portion comprises a camera of 4920×3280 pixels for acquiring image data at up to 3.2 Hz.

9. The method of claim 7 wherein said adjustable distance is 1-20 cm.

10. The method of claim 8 wherein said camera can achieve a 0.5-5.5 μm/pixel resolution.

11. The method of claim 7 wherein said system can be configured to acquire image data continuously or in a burst mode.

12. The method of claim 7 comprising respective shutters for each of said windows.
